(19) United States
(12) Patent Application Publication
(10) Pub. No.: US 2004/0127678 A1
(43) Pub. Date: Jul. 1, 2004

(54) Process for preparing polyamide 6 having a low dimer content

(76) Inventors: Ralph Ulrich, Ratingen (DE); Konrad Triebeneck, Bergisch Gladbach (DE)

Correspondence Address: BAYER POLYMERS LLC, 100 BAYER ROAD, PITTSBURGH, PA, 15205, US

(21) Appl. No.: 10/701,315

(22) Filed: Nov. 4, 2003

(30) Foreign Application Priority Data
Nov. 7, 2002 (DE) 10251798.3

(51) Int. Cl. C08G 69/08

(52) U.S. Cl. 528/312; 528/323

(57) ABSTRACT

The present invention relates to a process for preparing polyamide 6 (PA 6) by hydrolytic polymerization of ε-caprolactam. In a first reaction step, a first intermediate mixture is formed by ring opening ε-caprolactam in the presence of water, under conditions of increased pressure and temperature. The first intermediate mixture is then dehydrated to form a dehydrated intermediate having a water content of less than 0.5 wt. %. The dehydrated intermediate is subsequently polymerized to. produce a polyamide 6 product having a low dimer content (e.g., of less than 0.3 wt. %). The invention also relates to an apparatus in which the process may be performed. The apparatus includes, in sequence, a pressure reactor (23) having heat exchange surfaces (36), a dehydration device (24) that is in fluid communication with the pressure reactor (23), and a main reactor (25) that is in fluid communication with the dehydration device (24).

### CROSS REFERENCE TO RELATED PATENT APPLICATION

The present patent application claims the right of priority under 35 U.S.C. §119 (a)-(d) of German Patent Application No. 102 51 798.3, filed Nov. 7, 2002.

### FIELD OF THE INVENTION

The present invention relates to a process for preparing polyamide 6 (PA 6) by hydrolytic polymerization of ε-caprolactam (referred to herein as “caprolactam” for purposes of brevity), wherein the opening of the caprolactam ring takes place in a first step by exposure to high water contents, and the polycondensation is performed at low temperatures relative to standard processes and with efficient dehydration in subsequent steps. In addition, the present invention relates to a device for performing the process according to the invention.

### BACKGROUND OF THE INVENTION

Polyamide 6 may contain other repeating components, terminal groups or other molecule components than those derived from ε-caprolactam in small proportions (in particular less than 20 wt. %, preferred 10 wt. %, particularly less than 5 wt. %). Nevertheless, it is described as polyamide 6.

Processes for preparing polyamide 6 are disclosed, for example in Kohan, Nylon Plastics Handbook, Carl Hanser Verlag, Munich, 1995 or in Kunststoff Handbuch, 3. Technische Thermoplaste, 4. Polyamide, Carl Hanser Verlag, Munich, 1998 (pages 42-47 and also 65-71). According to these publications, caprolactam is cleaved by exposure to water in a first step at least partially to form the corresponding aminocaproic acid, which is then polymerized further in the subsequent step with the removal of water by polyaddition and polycondensation.

On the industrial scale, PA 6 is produced in a so-called VK tube (VK is an abbreviation for the German “vereinfacht kontinuierlich” [“simplified continuous”]), in which liquid caprolactam is fed with approximately 1 to 4 wt. % water from above to one vertical tubular reactor or to a series of vertical tubular reactors. Excess water is distilled off. The polymerization is performed at temperatures between 240 and 270° C. with a dwell time of 15 to 30 hours. A marked acceleration of the process by a few hours can be achieved by inserting upstream a pressure stage in which the rate-determining cleavage of caprolactam is performed at increased pressure (i.e. at a pressure above normal atmospheric pressure) under otherwise similar conditions.

In this process scheme, the achievable viscosity (as a measure of the mean molar mass of the PA 6) is determined by the water content of the caprolactam melt. As a rule, relative viscosities around 2.6 to 3.0 (measured as a 1 wt. % solution in m-cresol at 25° C.) are achieved.

For thermodynamic reasons, the conversion is limited in this process. Thus, at equilibrium at 270° C., approximately 10 wt. % residual content of low-molecular-weight species, substantially caprolactam and cyclic oligomers of caprolactam (in particular, the dimer to the tetramer) are also present in addition to polyamide. In this connection, the cyclic dimer (also referred to below as the dimer) of caprolactam assumes a special position since it can result in problems, for example due to depositions during the further processing of the finished polymer.

This residual content drops significantly with decreasing temperature. Since the proportion of low-molecular-weight constituents has a troublesome effect on further applications, it is necessary to minimize the residual content. This can be done either by aqueous extraction of the PA 6 after polymerization or by vacuum delactamization of the PA 6 after polymerization or by optimized process control of the polymerization or a combination of vacuum delactamization with optimized process control or aqueous extraction with optimized process control.

In the case of low quality requirements, simple extraction in vacuo is sufficient. In that case, primarily caprolactam and only small amounts of oligomers are evaporated at high temperatures in vacuo (as disclosed in DE-A 19 844 176, EP-A 0 204 123, DE-A 4 328 013, U.S. Pat. No. 6,169,161, EP-A 1 095 960).

For more exacting applications of PA 6, such as, for example, extrusion applications, the melt is first pelletized and then extracted in hot water (as disclosed in EP-A 1 030 872, EP-A 0 792 672). In this way, appreciable amounts of oligomers can also be removed in addition to caprolactam. In this operation, the pellets absorb appreciable amounts of water (up to 12 wt. %).

In order to make it possible to process the PA 6, the extraction step must be followed by drying (as disclosed in EP-A 0 732 351, EP-A 0 407 876). In this process, the absorbed water is removed again by means of hot inert gas (nitrogen). For certain applications (for example, film applications), necessary viscosities higher than those mentioned above are conventionally achieved by increasing the temperature during drying (so-called solid-phase post-condensation).

Said solid-phase post-condensation is conventionally performed at temperatures ranging from 30 to 80° C. below the polymer melting point in vacuo or in an inert gas countercurrent. For example, proceeding from polyamide 6 having a relative viscosity of 2.8 (measured as a 1 wt. % solution in m-cresol at 25° C.), a relative viscosity of approximately 4 is achieved in 24 hours at 185° C.

Subsequently, the water extracted also has to be worked up since discarding the caprolactam and the oligomers is not economically acceptable (as disclosed in DE-A 19 801 267, EP-A 0 048 340, DE-A 2 501 348). For this purpose, the aqueous extraction solution is concentrated in suitable multistage evaporation plants until it can be used again in the reaction.

The purification of the PA 6 polymer melt is consequently a complicated and cost-intensive process. The object of an optimum reaction procedure must therefore be to achieve a high conversion of caprolactam and to form as small amounts of cyclic oligomers as possible. As is known, high conversions of caprolactam can be achieved by reducing the melt temperature at the end of the reaction. At low temperatures, the equilibrium caprolactam content is about 7 wt. %. This scheme is generally used and has long proved satisfactory.

PA 6 can be polymerized batchwise (i.e. in a plurality of consequence charges performed discontinuously) in one stage (for example, in a VK tube) or, alternatively, in two stages (as disclosed in Kunststoffhandbuch volume 3/4, Polyamides, 1998, Hanser Verlag, pages 67 to 68).

The following three phases are common to all reaction procedures:

1. Opening of the caprolactam ring,

2. Removal of water,

3. Further molecular-weight build-up (build-up of the mean molar mass of the PA 6).

These three phases are also reflected in the batch reaction process and/or in the interconnection and design of the continuously operated equipment. In the chargewise procedure (synonymous with batchwise), the caprolactam is first cleaved under pressure. For this purpose, the molten caprolactam is brought with a small amount of water (less than 2 wt. %) to a starting temperature of about 240° C. The exothermic initial reaction results in an appreciable increase in temperature in the melt. Caprolactam is cleaved until the equilibrium conversion is reached. The prepolymer then still contains 8 wt. % to 10 wt. % monomer (caprolactam). Water and monomer are then expelled by reducing the pressure (down to the ambient pressure or even to vacuum). This displaces the equilibrium in the direction of higher degrees of polymerization. Finally, reaction is continued at moderate temperatures (250° C.) until the desired molecular weight is achieved. This procedure results in low contents of caprolactam in the finished polymer.

The two-stage continuous polymerization of PA 6, in which the caprolactam ring-opening reaction proceeds under pressure in the first stage, takes a form analogous to the single-stage polymerization of PA 6. This step preferably proceeds adiabatically and produces a prepolymer that, although it has a low mean molecular weight, already exhibits a high caprolactam conversion. The prepolymer melt is then heated and let down into the second stage. This results in evaporation of water and caprolactam. Caprolactam is conventionally retained by an attached distillation column and associated condenser and is fed back again directly to the reactor. Only water leaves the equipment at the top. In the upper section of the second stage (let-down stage), the heat removed from the melt by evaporation of water and lactam is fed back to it again. Further down in the reactor, the melt is then cooled in order to achieve as high a conversion as possible.

In the single-stage continuous polymerization of PA 6, the process scheme is more extensively integrated than in the two-stage polymerization. In the upper section of the reactor, the ring-opening reaction and water removal proceed simultaneously. In terms of equipment, this scheme is simpler than the two-stage variant, but it requires more dwell time in total.

The polymerization reactors are conventionally operated in such a way that the polymer melt is at reaction equilibrium, as far as caprolactam content and molecular weight are concerned, at the outlet of the equipment or at the end of the reaction process. This is also accompanied by a certain content of cyclic oligomers. In the normal case, however, said content is not in equilibrium since the latter is established markedly more slowly in the case of the oligomers than in the case of the monomer content and the molecular weight. This is disclosed in Tai, Tagawa, Simulation of hydrolytic polymerization of caprolactam in various reactors, Industrial and Engineering Chemistry Product Research and Development, pages 192 to 206,1983. The dimer content of the melt that leaves the reactor depends on the conditions passed through in the reactor (in particular, it depends on water content and temperature). In conventional two-stage reactors, comprising a pressure stage (2 wt. % water, 250° C. to 280° C., 8 bar, adiabatic) and a let-down stage 270° C. to 250° C., 1 bar), lactam contents of about 7 wt. % and dimer contents of about 0.7 wt. % are achieved. Although the value for the dimer is still below the equilibrium value (approximately 1 wt. %), it is not far removed from it.

### SUMMARY OF THE INVENTION

Proceeding from the processes known in the prior art for preparing polyamide 6, the object of the present invention is to provide a process for preparing polyamide 6 in which the polyamide 6 has as low a content as possible of cyclic dimers of ε-caprolactam after the polymerization.

Furthermore, the object of the present invention is to provide a device in which said process can be performed.

In accordance with the present invention there is provided a process for preparing polyamide 6 comprising:

(a) ring opening ε-caprolactam in the presence of water in a first reaction stage to form a first intermediate mixture, the ring opening being performed at,

a pressure above normal atmospheric pressure,

at a temperature of 230° C. to 250° C., and

with a water content having a positive value of no greater than 10 percent by weight, based on the sum of the weight of ε-caprolactam and the water (e.g., a water content of from 2 wt. % to 10 wt. %, or from 4 wt. % to 9 wt. %, or from 6 wt. % to 9 wt. %);

(b) dehydrating the first intermediate mixture of step (a) by subjecting the first intermediate mixture to heat, thereby producing a dehydrated intermediate having a water content of less than 0.5 percent by weight, based on the total weight of the dehydrated intermediate; and

(c) polymerizing the dehydrated intermediate in a second reaction stage at,

an absolute pressure of between 1 mbar and 1013 mbar,

and at a temperature of 230° C. to 250° C., thereby forming polyamide 6.

In further accordance with the present invention there is also provided an apparatus for preparing polyamide 6 comprising:

(a) a pressure reactor (23) having an inlet (30), an outlet (33)

and preferred heat exchange surfaces (36),

(b) a dehydration device (24) having an inlet (39) and an outlet (42), the inlet (39) of said dehydration device being in fluid communication with the outlet (33) of said pressure reactor; and

(c) a main reactor (25) having an inlet (45) that is in fluid communication with the outlet (42) of said dehydration device (24).

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions, such as those expressing structural dimensions, quantities of ingredients, etc. used in the specification and claims are understood as modified in all instances by the term “about.”

### BRIEF DESCRIPTION OF THE DRAWING FIGURES

FIG. 1 is a schematic representation of a two-stage continuous polymerization apparatus that may be used to perform the process of the present invention;

FIG. 2 is a schematic representation of a one-stage continuous polymerization apparatus according to the prior art; and

FIG. 3 is a schematic representation of a two-stage continuous polymerization apparatus that includes a pressure reactor (23) having heat exchange surfaces (33).

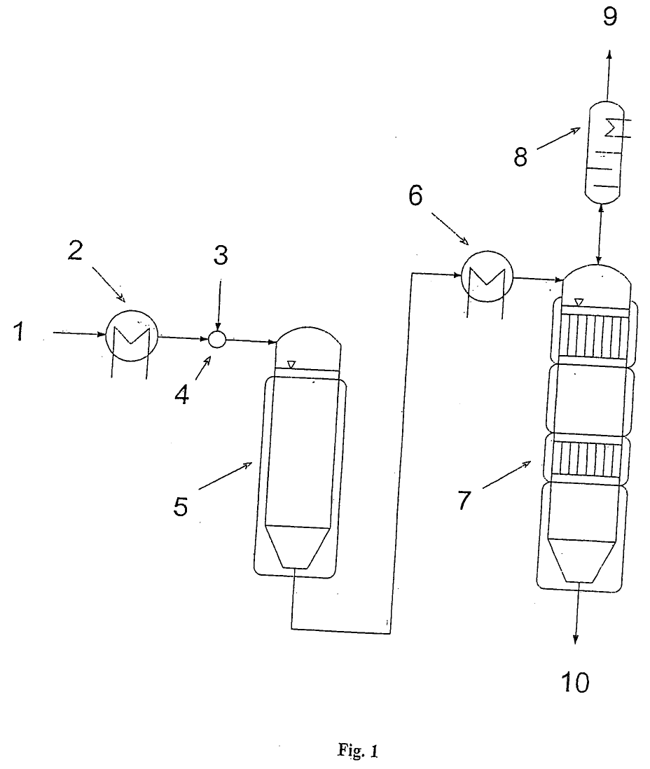

In FIGS. 1 through 3, like reference numerals designate the same operations and components.

### DETAILED DESCRIPTION OF THE INVENTION

An embodiment of the present invention is provided if the second reaction stage is conducted in a device selected from the group comprising a falling strand evaporator, a loop-type evaporator, a thin-film evaporator, a disc reactor and a kneading reactor.

A further embodiment of the present invention is provided if the process is conducted discontinuously (batch-wise).

A further embodiment of the present invention is provided if the dehydration is performed in a device that comprises a separating column with which the escape of ε-caprolactam from the device can be prevented or at least suppressed.

A further embodiment of the present invention is provided if the first reaction stage is performed in a device that contains heat-exchange surfaces that are suitable for removing the excess reaction heat.

The process according to the invention has numerous advantages. Since the content of cyclic dimers of ε-caprolactam is low in the polyamide 6 obtained after polymerization, the expenditure associated with removing the cyclic dimers (by aqueous extraction or evaporation in vacuo) is significantly reduced. The process according to the invention has the advantage that this reduction is achieved solely by suitable choice of the reaction conditions (in particular, by suitable choice of the water content and of the temperature during polymerization). Furthermore, the process according to the invention has the advantage that it can provide polyamide 6 in a wide range of desired molar mass. In addition, the conversion of caprolactam is high. The water content is, in addition, high enough for no problems to occur as a result of mass transport or as a result of phase equilibria that would adversely affect the polymerization. In addition, the temperature during polymerization is sufficiently high for no solidification of the melt to occur. In addition, the water content during polymerization is low enough for no problems to occur owing to an excessively high pressure in the reactor.

The invention makes it possible to reduce the dimer content of the polymer melt to below 0.35 wt. %, based on the total weight of the polymer melt. The optimized profile continuously requires as low a temperature as possible during the polymerization of the PA 6. Surprisingly, it has emerged that the short first phase of the reaction should proceed in the presence of as much water as possible. Subsequently thereto, dehydration is performed to the greatest possible extent and then the polymerization is performed until the target viscosity is reached. The dimer content can be reduced by more than half (compared with conventional polymerizations) by this procedure. At the same time, the polymer melt is not in equilibrium in. regard to the molecular weight. In such a scheme, care should therefore be taken in preferred embodiments as a result of suitable measures (addition of regulators or water) that the polymer melt does not substantially alter its molecular weight during a plant outage.

The reaction procedure according to the invention can be implemented both in batchwise-operated plants and in continuously operated, two-stage plants. In a continuously operated plant, the first stage is operated under pressure (the pressure level depends on the water content) and water is then expelled by supplying heat. To retain the caprolactam, a separating column can be inserted downstream. The dehydrated melt is then preferably brought back to the desired reaction temperature and reacted further to achieve the required target viscosity. A further cooling of the melt while traversing the main reactor is unnecessary since processing is preferably performed without exception at the lowest possible temperature.

A wide variety of devices (so-called finishing reactors) can be used as the main reactor instead of a conventional VK tube. These primarily include all reaction vessels that are operated in vacuo and make available large surfaces for the exchange of materials (falling strand evaporators, loop-type evaporators, thin-film evaporators, disc reactors, kneading reactors). Thus, a subsequent extraction with water and drying can optionally be dispensed with or the extraction can be replaced by a vacuum delactamization. The reaction procedure according to the invention is particularly advantageous for such a procedure since the dimer removal is markedly facilitated by the low dimer content of the melt.

FIGS. 1 to 3 serve to illustrate the invention by way of example.

FIG. 1 shows a device for a two-stage continuous polymerization according to the prior art of PA 6.

Caprolactam 1 is fed to a preheater 2. Water 3 is then fed to the preheated caprolactam in a mixing device 4. This mixture is fed to a pressure reactor 5. The intermediate product mixture obtained from the pressure reactor 5 is fed to an evaporator 6 and then to the main reactor 7. On top of the main reactor 7 there is a separating column 8 by means of which the water can be removed. The finished polyamide 6 (10) is extracted at the lower end of the main reactor 7.

In this case, the pressure reactor 5 is operated adiabatically. Accordingly, it does not have any heat exchange surfaces.

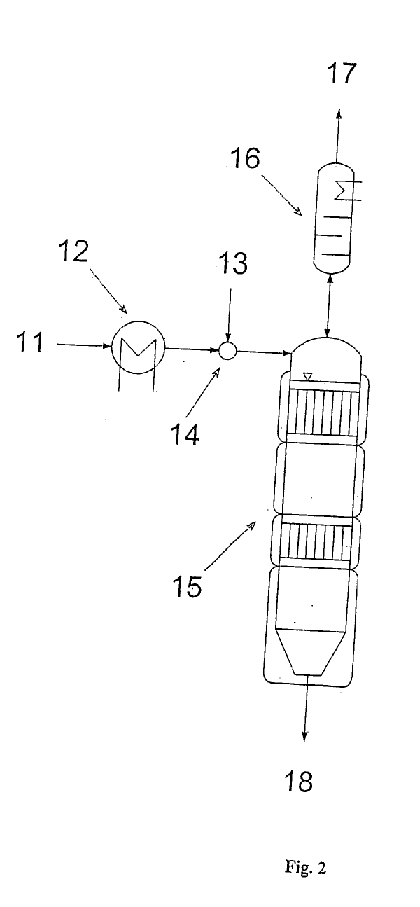

FIG. 2 shows a device for a one-stage continuous polymerization according to the prior art of PA 6.

Caprolactam 11 is fed to a preheater 12 and heated therein. Water 13 is then fed to the heated caprolactam in a mixing device 14. The mixture thus obtained is fed to the main reactor 15. The main reactor is connected at its upper end to a separating column 16 by means of which the water 17 can be removed. The finished polymer 18 is extracted at the lower end of the main reactor 15.

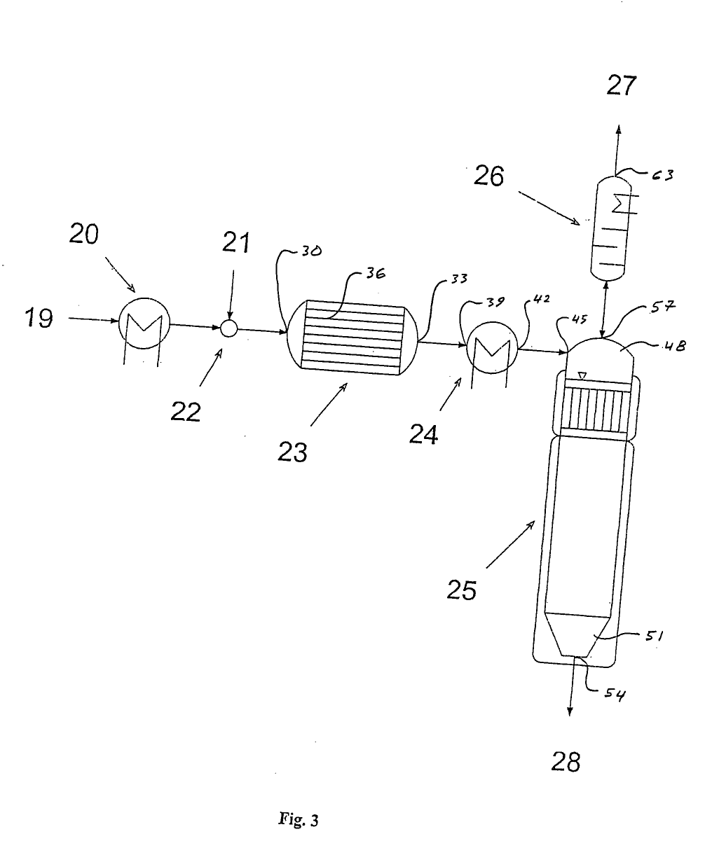

FIG. 3 shows a device for the polymerization according to the invention of PA 6.

Caprolactam 19 is heated in a preheater 20. Water 21 is then fed to the heated caprolactam in a mixing device 22. This mixture is fed to a pressure reactor 23 in which the first reaction stage of the process according to the invention proceeds. The intermediate product mixture obtained is then fed to an evaporator 24 (having an inlet 39 and an outlet 42) in which the intermediate product mixture is heated. The heated intermediate product mixture is then fed to a vertically oriented main reactor 25 (having upper 48 and lower 51 ends, a product outlet 54 at lower end 51, and an upper outlet 57 at upper end 48), in which the second reaction stage of the process according to the invention is performed. The upper outlet 57 of main reactor 25 is in fluid communication with the inlet 60 of a separating column 26. Separating column 26 provides a means by which the water 27 can be removed (e.g., through outlet 63 of column 26).

The finished polyamide 28 is extracted at the lower end 51 of the main reactor 25 through product outlet 54. To perform the dehydration, the water can: (i) already be removed in evaporator 24 (through an outlet not shown); or (ii) the water can be removed by means of the separating column 26; or both (i) and (ii) can be performed in combination.

In this case, heat is removed from the reaction mixture in the pressure reactor 23 in order to be able to keep the temperature low. The pressure reactor 23 therefore has preferably heat-exchange surfaces. In an embodiment of the present invention, the pressure reactor 23 is designed as a tubular heat exchanger.

### EXAMPLES

An example of the reaction procedure according to the invention is described below. It is based on the following boundary conditions:

| | |
|---|---|
| Maximum water content in the process | 10 wt. % |
| Minimum water content downstream of the evaporator | 0.5 wt. % |
| Minimum temperature | 230° C. |
| Required relative viscosity (m-cresol) | 2.5 |
| Maximum extract content in the polymer | 10 wt. % |

Extract content is understood as meaning the content of cyclic oligomers in the caprolactam. The extract content can be determined by HPLC. The extract content can also be determined gravimetrically by extracting the polymer, evaporating the extraction solution and weighing the dry extract.

### Example 1

The boundary conditions mentioned resulted in the following parameters for a reaction procedure according to the invention:

| | |
|---|---|
| Temperature throughout the process | 230° C. |
| Initial water content | 9 wt. % |
| Reaction time for the ring opening | ½ hour |
| Minimum total reaction time | 8 hours |

The water content was kept at 9 wt. % in the first half-hour and then reduced as quickly as possible to the minimum water content determined by pressure and temperature chosen. After reaching the desired molecular weight, the reaction was terminated.

9.1 kg of ε-caprolactam was introduced into an autoclave and heated to 230° C. After heating the autoclave, 0.9 kg of water was added within 20 min. The temperature control system of the reactor kept the melt constantly at 230° C. during the entire experiment. After terminating the addition of water, reaction was performed for half-an-hour, letting down was performed within approximately 90 minutes and reaction was then performed for approximately 9 hours at 230° C. The results of the analyses of the polymer melt are shown in Table 1.

### Comparison Example 1

A VK tube combined with a pressure stage was used as continuously operated polymerization reactor. The dwell time in the pressure stage was 2 hours at a temperature of 275° C. The water loading was 2 wt. %. A temperature of 280° C. was established in the upper section of the VK tube and a temperature of 250° C. in the lower section. The dwell time was 8 hours.

The results of the analyses of the polymer melt are shown in Table 1.

### Comparison Example 2

10 kg of ε-caprolactam and 0.5 kg of water were introduced into an autoclave and heated to a reaction temperature of 270° C. The reaction time was 10 hours. The temperature control system of the reactor kept the melt at 270° C. during the entire experiment.

The results of the analyses of the polymer melt are shown in Table 1.

TABLE 1

| | Total | Caprolactam | | |
|---|---|---|---|---|
| | reaction | content of the | Dimer content of | Relative |
| Experiment | time | PA 6 obtained | the PA 6 obtained | viscosity |
| 1 | 10.7 h | 6.8 wt. % | 0.32 wt. % | 3.31 |
| Comparison | 10.0 h | 8.2 wt. % | 0.65 wt. % | 3.30 |
| Example 1 | | | | |
| Comparison | 10 h | 8.6 wt. % | 0.53 wt. % | 2.56 |
| Example 2 | | | | |

The examples show that the process according to the invention results in a polyamide 6 of sufficiently high mean molar mass (judged on the basis of the relative viscosity) and that the polyamide 6 according to the invention contains a low caprolactam content and, in particular, a low cyclic dimer content.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing polyamide 6 comprising:
(a) ring opening ε-caprolactam in the presence of water in a first reaction stage to form a first intermediate mixture, the ring opening being performed at,
a pressure above normal atmospheric pressure,
at a temperature of 230° C. to 250° C., and
with a water content having a positive value of no greater than 10 percent by weight, based on the sum of the weight of ε-caprolactam and the water;
(b) dehydrating the first intermediate mixture of step (a) by subjecting the first intermediate mixture to heat, thereby producing a dehydrated intermediate having a water content of less than 0.5 percent by weight, based on the total weight of the dehydrated intermediate; and
(c) polymerizing the dehydrated intermediate in a second reaction stage at,
an absolute pressure of between 1 mbar and 1013 mbar,
and at a temperature of 230° C. to 250° C., thereby forming polyamide 6.

2. The process of claim 1 wherein the second reaction stage is performed in a device selected from the group comprising a falling strand evaporator, a loop-type evaporator, a thin-film evaporator, a disc reactor and a kneading reactor.

3. The process of claim 1 wherein the process is performed discontinuously.

4. The process of claim 1 wherein the dehydration step (b) is performed in a dehydrating device comprising a separating column, the escape of ε-caprolactam from said dehydrating device being at least minimized.

5. The process of claim 1 wherein the first reaction stage is performed in a reactor that contains heat-exchange surfaces that are suitable for removing excess reaction heat.

6. The process of claim 1 wherein the polyamide 6 produced by said process has a dimer content of less than 0.35 percent by weight.

7. The process of claim 1 wherein the polymerization of step (a) is performed under adiabatic conditions.

8. An apparatus for preparing polyamide 6 comprising:
(a) a pressure reactor having an inlet, an outlet and heat exchange surfaces,
(b) a dehydration device having an inlet and an outlet, the inlet of said dehydration device being in fluid communication with the outlet of said pressure reactor; and
(c) a main reactor having an inlet that is in fluid communication with the outlet of said dehydration device.

9. The apparatus of claim 8 wherein said main reactor is oriented vertically having upper and lower ends, said main reactor having a product outlet at the lower end, and an upper end outlet, said apparatus further comprising a separating column that is in fluid communication with the upper outlet of said main reactor.
